(19) United States
(12) Patent Application Publication
(10) Pub. No.: US 2017/0192032 A1
(43) Pub. Date: Jul. 6, 2017

(54) Flexible Readout Circuit for Capacitive Transducers

(71) Applicant: Saber Amini Baghbadorani, Ottawa (CA)

(72) Inventor: Saber Amini Baghbadorani, Ottawa (CA)

(21) Appl. No.: 14/988,718

(22) Filed: Jan. 5, 2016

(51) Int. Cl. G01P 15/08; G01P 15/125

(52) U.S. Cl. CPC G01P 15/0802; G01P 15/125

(57) ABSTRACT

A readout circuit for processing a transducer signal from a capacitive transducer and producing a circuit output signal, where the readout circuit includes a signal path and a separate feedback path. The signal path includes a sensing element and a capacitance to electrical signal converter. The feedback path includes the sensing element and a capacitance to electrical signal converter. The forward path outputs a signal that as a time average is substantially proportional to the difference in the variable capacitors of the sensing element. The high gain circuit receives the output signal of the summer and generates an amplified signal. The output circuitry generates the output circuit signal based on the output of the high gain circuit element.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This inventions relates to capacitive transducers. More specifically, the invention pertains to techniques for increasing the fidelity of signals achieved from capacitive transducers using readout circuits.

In the past decade, there has been a proliferation of the use of transducers in measuring physical quantities for various applications.

Due to ease of manufacturing, low cost and temperature stability, capacitive transducers are widely employed. These transducers work by converting an acceleration into a change in capacitance. Readout circuits for capacitive transducers then convert this change in capacitance to an electrical signal. The acceleration may be due directly to an object or be the byproduct another physical phenomena that is of interest.

The capacitive transducer has two sets of variable capacitors with a nominal capacitance of Cₛ at rest. Once the capacitive transducer undergoes acceleration, the acceleration will cause a displacement x. As a result of this displacement, each variable capacitor changes differentially according to:

$$\begin{matrix}{C}_{s}^{+} = \frac{{C}_{s}}{1 - \frac{x}{d}} & ( 1 ) \\ {C}_{s}^{-} = \frac{{C}_{s}}{1 + \frac{x}{d}} & ( 2 )\end{matrix}$$

where x is the displacement due to a physical phenomena and d is the equivalent distance between each variable capacitor plate at rest. The value x is proportional to the physical phenomena of interest and knowing its relative value is important in many applications.

When the system is at rest, the displacement x is substantially zero and as such the capacitance of the first variable capacitor, Cₛ⁻ is substantially equal to the capacitance of the second variable capacitor Cₛ⁺ as shown in (1) and (2).

A method to quantify how closely the output of a readout circuit matches the actual value of x is to measure the output fidelity through the signal-to-noise ratio (SNDR).

SNDR is a ratio of signal power to the sum of noise and distortion powers.

To achieve high SNDR, one aims to increase signal power, reduce noise or reduce distortion or a combination of these.

For readout circuits, a method to reduce distortions is to have an output that is ratiometric and charge balanced.

In ratiometric implementations, the output signal is the ratio between the difference in variable capacitors over its sum. Such a technique results in an output that is linearly proportional to acceleration as shown below:

$${V}_{out} = K \frac{{C}_{s}^{+} - {C}_{s}^{-}}{{C}_{s}^{+} + {C}_{s}^{-}} = K \frac{x}{d} \qquad ( 3 )$$

where wₙ, is the natural frequency associated with the mechanical resonance of the transducer, x is the displacement due to acceleration, d is the distance between the capacitive plates at rest and K is a gain factor.

(3) is an exact equation without simplifications and thus it may suggest that any readout circuit that achieves a ratiometric output is highly linear. This, however, is not the case. The caveat is that readout circuits inevitably involve placing currents, voltages, or charges or a combination of these on one and/or both plates of the variable capacitors. The force acting on a capacitor is given by

$$F = \frac{A {ε}_{r} {ε}_{0}}{2 {d}^{2}} {V}^{2} \qquad ( 4 )$$

where V is the potential difference across the capacitor, ε₀ is the permittivity of free space, εᵣ is the relative permittivity and A is the equivalent plate area of each variable capacitor. When the variable capacitors undergo acceleration, the capacitance changes in opposite directions and therefore, the electrostatic force on each capacitor is slightly different. These forces in turn cause an unwanted displacement or disturbances that cause even and odd harmonics mitigating any benefits of the ratiometric technique.

To overcome this problem, readout techniques aim to charge balance the output by dynamically adjusting the voltage across each variable capacitor such that the charge and hence the force on each capacitor is equal and therefore, the displacements are equal and do not affect the output. The concept is based on some form of feedback where the output is fed back as a charge on the variable capacitors. The difference is then amplified and the output is adjusted.

In other words, using feedback, the average charge on the variable capacitors will be zero and as such, the average force will be zero, reducing the harmonics caused by the charge placed on the variable capacitors by the readout circuit.

FIG. shows an exemplary version of the charge balanced ratiometric circuit. The circuit is a switch capacitor based analog feedback system. [Leuthold and Rudolf, 1990]

Analysis of this circuit shows that its output is given by:

$${V}_{o } ( z ) = {V}_{ref} \frac{{C}_{s}^{+}}{\frac{{C}_{f}}{{C}_{4}} {C}_{3}} \frac{z}{z - ( 1 - \frac{{C}_{s}^{+} + {C}_{s}^{-}}{{C}_{f}} \frac{{C}_{4}}{{C}_{3 }} )} \qquad ( 5 )$$

where V_{ref} is a DC reference voltage. Note that at DC (z=1), we have a ratiometric output.

However, it is well known that in a feedback system, the gain of the feedback signal is proportional to the gain of the system. If the amplitude of the feedback signal is too high relative to the input signal, then this reduces the power of the output signal. In a normal feedback system, the power of the input signal and feedback signal can be adjusted to obtain an optimal value, for example, in order to achieve maximum SNDR.

In the charge balance ratiometric circuit of FIG., the structure of the capacitive transducer does not allow for the input signal and the feedback signal to be adjusted independently. The input signal is proportional to the difference in variable capacitors while the feedback is proportional to sum of the variable capacitors. Therefore, depending on the sensitivity and size of the variable capacitors, the feedback signal may be too large relative to the input signal and reduce the output signal level.

The only parameter to increase the input signal is the reference voltage, V_{ref}. This, however, is limited from the perspective of the available supply sources. Even if mechanisms such as charge pumps are used to generate a high reference voltage, ultimately the reference voltage value is limited by the pull-in phenomena associated with mechanical capacitors [Bao, 2005].

Over the years, other charge balanced and ratiometric readout circuits have been implemented [Cao and Temes, 1994, Paavola et al., 2009]. However, the feedback mechanism is similar to the Leuthold-Rudolf integrator and therefore, the systems can suffer from low output power that limits the achievable SNDR. When low sensitivity transducers are used, the output power level is considerably low relative. Even if high sensitivity accelerometers are available, it may be advantageous to only use a fraction of the possible range since transducers suffer worse linearity at higher deflection.

What is needed is a flexible technique that makes use of the benefits of charge balance ratiometric output but does not mitigate these benefits by reduction in the output power. This will allow transducers of varying sensitivities and dynamic ranges to be optimally tuned maximizing fidelity at minimum cost and allowing for more diverse applications.

### SUMMARY OF THE INVENTION

A readout circuit is disclosed for processing a transducer signal from a capacitive transducer and producing a circuit output signal, where the readout circuit includes a signal path and a separate feedback path. The signal path includes a sensing element and a capacitance to electrical signal converter. The feedback path includes the sensing element and a capacitance to electrical signal converter. The signal path's capacitance to signal converter outputs a signal that as a time average is substantially proportional to the difference in the variable capacitors of the sensing element. The feedback path's capacitance to signal converter outputs a signal that serves to create a negative feedback relative to the output signal. A summer receives the output of the signal path and the feedback path and generates a summation signal. The high gain circuit receives the output signal of the summer and generates an amplified signal. The output circuitry generates the output circuit signal based on the output of the high gain circuit element. The high gain circuit element can be a switched capacitor integrator. The capacitance to electrical signal converters can include operational amplifiers.

### BRIEF DESCRIPTION OF THE DRAWINGS

For a more complete understanding of the invention, reference is made to the following description and accompanying drawings, in which:

FIG. 1 is schematic of an exemplary charge balanced ratiometric system;

FIG. 2 is a schematic of an exemplary capacitive transducer system in which the feedback path is separate from the signal path by using time multiplexing of the feedback and signal path;

FIG. 3 shows a time diagram of various clock signals during several cycles for the readout circuit of FIG. 2 according to the invention;

FIG. 4 is a schematic of an exemplary capacitive transducer system in which the feedback path is separate from the signal path by employing a capacitive transducer having two sensing cores;

FIG. 5 is a schematic of differential version of an exemplary capacitive transducer system in which the feedback path is separated from the signal path; and

FIG. 6 shows a time diagram of various clock signals during several cycles for the readout circuit of FIG. 5 according to the invention.

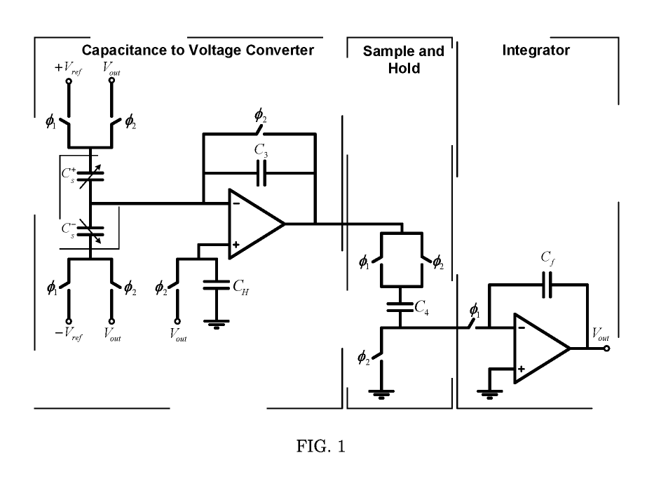

### DETAILED DESCRIPTION OF EXEMPLARY EMBODIMENTS

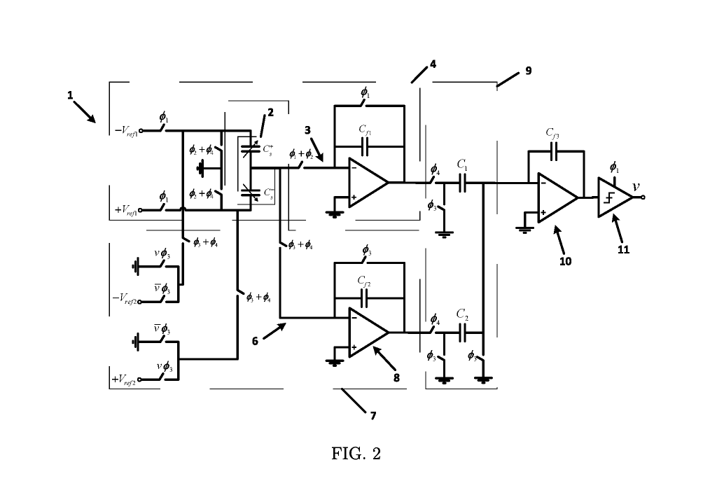

FIG. 2 shows an exemplary system [1] in which feedback gain can be set independently from the transducer signal gain [Amini and Johns, 2015a]. The system [1] includes a sensing element [2], a feedback path [6] and a signal path [3].

The signal path [3] contains the sensing element [2] and a switched capacitor amplifier [5] and together these form the signal path's capacitor to voltage converter [4].

The signal path's capacitor to voltage converter [4] employs two reference voltages +V_{ref1} and −V_{ref1} each having substantially the same magnitude but opposite polarity. The capacitor to voltage converter [4] generates an intermediate output signal Vₒ₁ that is proportional to the difference in variable capacitors:

$${V}_{o 1} = {V}_{ref 1} \frac{{C}_{s}^{+} - {C}_{s}^{-}}{{C}_{f 1}} \qquad ( 6 )$$

The feedback path [6] includes the sensing element [2] and a switched capacitor amplifier [8] and together these form the feedback path's capacitor to voltage converter [7]. The feedback path's capacitor to voltage converter [7] employs two reference voltages +V_{ref2} and −V_{ref2} each having substantially the same magnitude but opposite polarity.

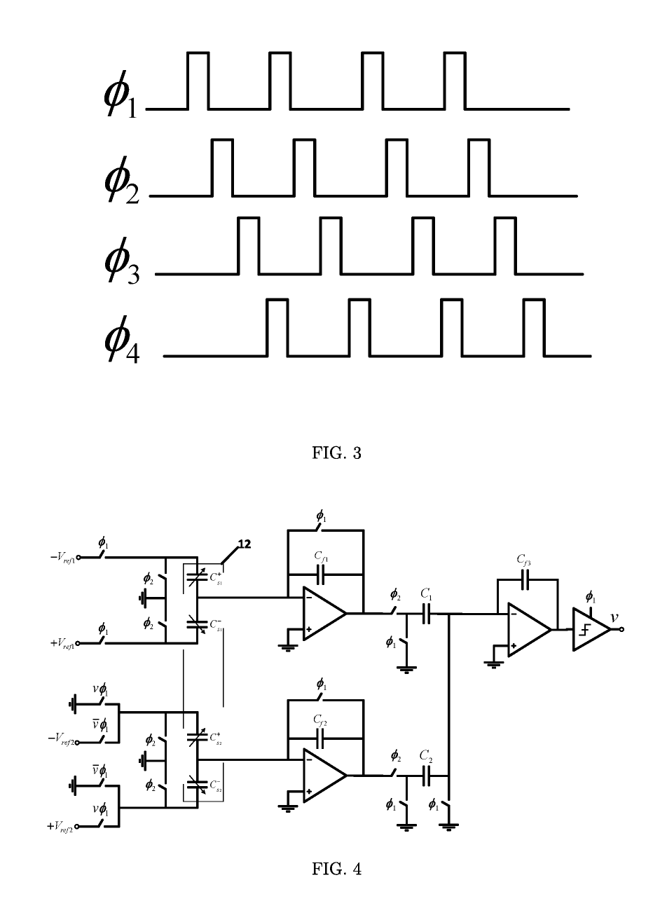

In the preferred embodiment shown in FIG. 2, the system [1] separates the signal path [3] from the feedback path [6] by employing four non-overlapping clock signals and appropriate switches. In one set of clock phases, the difference in variable capacitors is sampled and amplified as shown in (6). In the next set of phases, the feedback path is activated. This can also be referred to as time multiplexing of the signal path and the feedback path. The corresponding clock signals for the system [1] are shown in FIG. 3.

Once the feedback path is activated, the feedback path's capacitor to voltage converter [7] outputs an intermediate voltage Vₒ₂, the value of which creates a negative feedback affect compared to the output of the integrator [10]. If the output of the integrator [10] is high relative to a chosen reference voltage, then the feedback path's capacitance to voltage converter [7] will output a value that will cause the output of the integrator [10] to fall. If the output of the integrator [10] is lower relative to the chosen reference voltage, the feedback path's capacitance to voltage converter [7] will output a value that will cause the output of the integrator [10] to rise.

The summer [9] then receives the output of the signal path's capacitance to voltage converter [4] and the feedback path's capacitance to voltage converter [7] and generates a summation signal. The switched capacitor integrator [10] receives the output of the summer and generates an amplified output signal. The comparator [11] then receives the output of the integrator [10] and compares the output to the chosen reference voltage outputting a signal υ if the output is higher relative to the reference voltage and outputting another signal υ̅ if the output of the integrator is lower than the chosen reference voltage. The signal level of υ and υ̅ are substantially differential to the chosen reference voltage.

Due to the negative feedback and high gain of the integrator [10], the total charge at the input of the integrator [10] must be zero, therefore, the following equations can be applied:

$$- {nV}_{ref 2} {C}_{s}^{-} \frac{{C}_{2}}{{C}_{f 2}} + ( N - n ) {V}_{ref 2} {C}_{s}^{+} \frac{{C}_{2}}{{C}_{f 2}} + {NV}_{{ref}_{1}} ( {C}_{s}^{+} - {C}_{s}^{-} ) \frac{{C}_{1}}{{C}_{{f}_{1}}} = 0 \\ {NV}_{{ref}_{1}} ( {C}_{s}^{+} - {C}_{s}^{-} ) \frac{{C}_{1}}{{C}_{{f}_{1}}} = {V}_{{ref}_{2}} \frac{{C}_{2}}{{C}_{{f}_{2}}} ( {nC}_{s}^{-} + {nC}_{s}^{+} - {NC}_{s}^{+} ) \\ \frac{{C}_{s}^{+} - {C}_{s}^{-}}{{C}_{s}^{+} + {C}_{s}^{-}} = \frac{{V}_{ref 2}}{{V}_{{ref}_{1}}} \frac{{C}_{2}}{{C}_{1}} \frac{{C}_{{f}_{1}}}{{C}_{{f}_{2}}} ( \frac{n}{N} - \frac{{C}_{s}^{+}}{{C}_{s}^{+} + {C}_{s}^{-}} ) \\ {B}_{ave} = \frac{1}{2} + ( \frac{{V}_{ref 1}}{{V}_{{ref}_{2}}} \frac{{C}_{1}}{{C}_{2}} \frac{{C}_{{f}_{2}}}{{C}_{{f}_{1}}} + \frac{1}{2} ) \frac{{C}_{s}^{+} - {C}_{s}^{-}}{{C}_{s}^{+} + {C}_{s}^{-}} \\ where \\ {B}_{ave} = \frac{n}{N} \qquad ( 7 )$$

and is the average value of the output of the comparator [11]. The difference here compared to other charge balanced ratiometric circuits is that the signal path's [3] gain and the feedback path's [6] gain can now be adjusted widely by three ratios allowing to maximize the output power for a varying dynamic range and sensitivities in order to achieve maximum SNDR.

The exemplary system of FIG. 2 separates the feedback path from the signal path in the time domain. It is possible to achieve separation of the feedback and signal path by using a capacitive transducer with two core sensing elements.

FIG. 4 shows another embodiment of the invention whereby the capacitive sensing element [12] comprises a first capacitive core and a second capacitive core. The signal path comprises of the first capacitive core, and the feedback path comprises of the second capacitive core. The variable capacitances of the cores are substantially the same with Cₛ₁⁺≈Cₛ₂⁺ and Cₛ₁⁻≈Cₛ₂⁻.

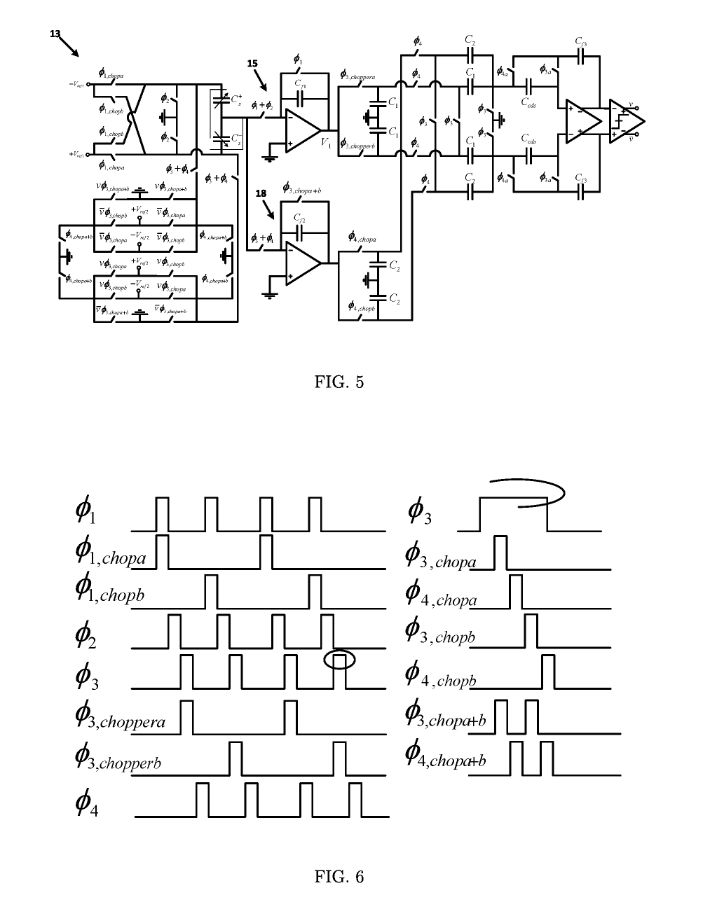

FIG. 5 shows an exemplary differential system [13] [Amin and Johns, 2015b] where the signal path [15] is separated from the feedback path [18] using the time multiplexing similiar to the system [1] of FIG. 2. The corresponding clock signals for the system are shown in FIG. 6.

What is claimed:

1. A readout circuit for processing a transducer signal from a capacitive transducer and producing a circuit output signal, the readout circuit comprising:
a) a signal path including a sensing element and a capacitance to electrical signal converter;
b) a separate feedback path including the sensing element and a capacitance to electrical signal converter;
c) a summer summing the output of the signal path and the feedback path and generating a summation signal;
d) a high gain circuit element receiving the output of the summer and generating an amplified output signal; and
e) output circuitry generating the output circuit signal based on the output of the high gain circuit element.

2. The readout circuit of claim 1, wherein separation of the feedback path and the signal path is achieved by activating the feedback path's capacitance to electrical signal converter in one time period and activating the signal path's capacitance to electrical signal converter in a separate, non-overlapping time period.

3. The readout circuit of claim 2, further consisting of a comparator that receives the output of the high gain circuit, compares the output to a chosen reference voltage and generates an output signal if the output of the high gain circuit is higher than the chosen reference voltage and a different output signal if the output of the high gain circuit is lower than the chosen reference voltage and output circuitry generating the output circuit signal based on the output signal of the comparator.

4. The readout circuit of claim 1, wherein the capacitive sensing element comprises a first capacitive core and a second capacitive core, and the signal path comprises of the first capacitive core, and the feedback path comprises of the second capacitive core.

5. The readout circuit of claim 4, further consisting of a comparator that receives the output of the high gain circuit, compares the output to a chosen reference voltage and generates an output signal if the output of the high gain circuit is higher than the chosen reference voltage and a different output signal if the output of the high gain circuit is lower than the chosen reference voltage and output circuitry generating the output circuit signal based on the output signal of the comparator.

6. A readout circuit for processing a transducer signal from a capacitive transducer and producing a circuit output signal, the readout circuit comprising:
a) a signal path including a sensing element and a capacitance to electrical signal converter that generates a signal substantially proportional to the time average of the difference in variable capacitors;
b) a separate feedback path including the sensing element and a capacitance to electrical signal converter;
c) a summer summing the output of the signal path and the feedback path and generating a summation signal;
d) a high gain circuit element receiving the output of the summer and generating an amplified output signal; and
e) output circuitry generating the output circuit signal based on the output of the high gain circuit element.

7. The readout circuit of claim 6, wherein separation of the feedback path and the signal path is achieved by activating the feedback path's capacitance to electrical signal converter in one time period and activating the signal path's capacitance to electrical signal converter in a separate, non-overlapping time period.

8. The readout circuit of claim 7, further consisting of a comparator that receives the output of the high gain circuit, compares the output to a chosen reference voltage and generates an output signal if the output of the high gain circuit is higher than the chosen reference voltage and a different output signal if the output of the high gain circuit is lower than the chosen reference voltage and output circuitry generating the output circuit signal based on the output signal of the comparator.

9. The readout circuit of claim 6, wherein the capacitive sensing element comprises a first capacitive core and a second capacitive core, and the signal path comprises of the first capacitive core, and the feedback path comprises of the second capacitive core.

10. The readout circuit of claim 9, further consisting of a comparator that receives the output of the high gain circuit, compares the output to a chosen reference voltage and generates an output signal if the output of the high gain circuit is higher than the chosen reference voltage and a different output signal if the output of the high gain circuit is lower than the chosen reference voltage and output circuitry generating the output circuit signal based on the output signal of the comparator.
